(19) United States
(12) Patent Application Publication
(10) Pub. No.: US 2006/0256259 A1
(43) Pub. Date: Nov. 16, 2006

(54) Stereoscopic image display apparatus

(76) Inventors: Ayako Takagi, Yokosuka-Shi (JP); Kazuki Taira, Tokyo (JP); Rei Hasegawa, Yokohama-Shi (JP); Yuko Kizu, Yokohama-Shi (JP); Yuzo Hirayama, Yokohama-Shi (JP); Rieko Fukushima, Tokyo (JP); Tatsuo Saishu, Tokyo (JP); Hitoshi Kobayashi, Kawasaki-Shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/377,437

(22) Filed: Mar. 17, 2006

(30) Foreign Application Priority Data
Mar. 29, 2005 (JP) 2005-95607

(51) Int. Cl. G02F 1/1335

(52) U.S. Cl. 349/95

(57) ABSTRACT

It is possible to reduce a crosstalk amount and stray light even if a viewing zone angle is wide or large. A stereoscopic image display apparatus includes: a flat display device and a beam controlling element provided on a front face of the flat display device. The beam controlling element includes: a first lens array having a plurality of lenses, a second lens array having a plurality of lenses, and a third lens array provided between the first lens array and the second lens array and having a plurality of lenses. The third lens array is configured such that each lens thereof on the first lens array side coincides with a corresponding lens thereof on the second lens array, and refractive indexes of the first and the second lens arrays are approximately the same, and a refractive index of the third lens array is different from the refractive indexes of the first and the second lens arrays.

### CROSS-REFERENCE TO RELATED APPLICATION

This application is based upon and claims the benefit of priority from prior Japanese Patent Application No. 2005-95607 filed on Mar. 29, 2005 in Japan, the entire contents of which are incorporated herein by reference.

### BACKGROUND OF THE INVENTION

1. Field of the Invention

The present invention relates to a stereoscopic image display apparatus.

2. Related Art

A method which record a stereoscopic image utilizing any means and reproduces the stereoscopic image, called an integral photography system for displaying many parallax images (hereinafter, called “IP systems”) or a beam reproducing system has been known. It is assumed that a viewer observes or views an object or a point. When an angle of the object positioned at a close distance defined by his/her left and right eyes is represented as α and an angle of the object positioned at a far distance defined by his/her left and right eyes is represented as β, α and β change according to a positional relationship between the object and the viewer. The (α−β) is called “binocular parallax”, and a person is sensitive to the binocular parallax and can view an object as a stereoscopic object.

In recent years, development of autostereoscopic image display apparatuses has been advanced. Many of the autostereoscopic image display apparatuses are provided with an ordinary flat display device (a two-dimensional display device) and a beam controlling element disposed on a front face side or a rear face side of the flat display device. An angle of light rays from the flat display device can be controlled by the beam controlling element utilizing the binocular parallax so as to appear as if the rays are emitted from an object positioned at a distance of several centimeters or so spaced from the flat display device, when the object is viewed by the viewer. This is because, even if light rays from the flat display device are distributed to several kinds of angles (called “parallax”), an image with a high fineness to a certain extent can be obtained owing to high fineness displaying on the flat display device.

When a lenticular lens or sheet is used as the beam controlling element, since it has a utilization efficiency of light higher than that of a slit member, such merit is obtained that display is bright. However, the stereoscopic image display apparatus is provided with not only a function of displaying a stereoscopic image (a three-dimensional image) (a three-dimensional image display mode) but also a function of displaying a flat image (a two-dimensional image) (a two-dimensional image display mode). In such a stereoscopic image display apparatus, for performing switching or conversion between the two-dimensional image display mode and the three-dimensional image display mode, it is necessary to generate or annihilate a curved face of the lenticular lens instantaneously. Since the curved face of the lens strongly affect image quality, when the lenticular lens sheet is used as the beam controlling element, it is difficult to perform such an operation, namely, instantaneous generation and annihilation, as compared with use of the slit member as the beam controlling element.

As described in International Publication No. WO03/015424 (hereinafter, called “Patent Literature 1”), there is disclosed a display apparatus which is added with an anisotropy lens and a flat display device for controlling a polarizing direction to electrically annihilate lens effect, thereby performing switching between a two-dimensional image display mode and a three-dimensional image display mode. Substance with birefringence is charged in a lens shape member and isotropic substance is charged at a position opposed thereto, so that rays in directions in which there is a difference in refractive index is condensed and light rays in directions in which there is no difference in refractive index form a two-dimensional image. In the technique described in Patent Literature 1, however, a single-sided convex lens is used as the beam controlling element. In a stereoscopic image display apparatus with multiple parallaxes and a large viewing zone angle using the single-sided convex lenses, a lens pitch becomes large and a radius of curvature becomes small when a difference in double refractive index is equal to an ordinary refractive index, and a step of a lens becomes large, so that it become impossible to form a single-sided convex lens. Even if light rays are condensed by the single-sided convex lens, crosstalk becomes large.

In JP-A-2000-503424, there is disclosed a stereoscopic image display apparatus which is provided with a display device which generates outputs from pixels arranged in a matrix array, for example, a matrix LC display panel, an array of lenticular elements which allows passage of outputs from various pixel groups, and a lenticular unit or means which forms at least one stereoscopic view which can appear in respective eyes of a viewer. The lenticular unit includes electro-optic material having electrically variable refractive index, and a two-dimensional image with a high resolution can be displayed by performing selective switching or conversion so as to remove behavior of the lenticular unit. In the JP-A-2000-503424, there is a description about an example of the single-sided lens but there is not any description about a method for increasing a viewing zone angle.

In JP-A-P2004-258631, there is a disclosed a stereoscopic image display apparatus which can display a two-dimensional image and a three-dimensional image in a switching or conversing manner. The stereoscopic image display apparatus described in JP-A-P2004-258631 is provided with a liquid crystal display device which includes a plurality of pixels arranged and outputs image light with polarization, a lens array which is provided on the liquid crystal display device and acts on light rays with a first polarization direction but does not act on light rays with a second polarization direction different from the first polarization direction, and a ½ wavelength film which is provided between the liquid crystal display device and the lens array and rotates a polarization plane of image light. In JP-A-P2004-258631, however, there is no proposal about improvement of a viewing zone angle in the lens array.

When the lens array is used as the beam controlling element in the stereoscopic image display apparatus, information of a neighboring parallax image is mixed in original parallax light rays, which is called “crosstalk”, so that stereoscopic display is obstructed. This is a phenomenon which takes place when a converging range reaches several sub-pixels in such a constitution that parallax rays in a certain direction are condensed on a two-dimensional display device (a flat display device) by the lens array.

In the three-dimensional image display device, a gap g between the two-dimensional display device and the beam controlling element is determined depending on the number of parallaxes and a viewing zone angle. Therefore, when the lens sheet is used as the beam controlling element, a radius of curvature of the lens is determined so as to cause a focal length to coincide with a design value. In a stereoscopic image display apparatus with a large viewing zone angle, since the gap between the lens array and the two-dimensional display device is small, a radius of curvature of the lens becomes small. Therefore, an aberration becomes large and crosstalk increases, which results in degradation of image quality. These problems must be overcome.

When a lens is formed, a difference between a refractive index of the lens and that of medium coming in contact with the lens affects a radius of curvature of a lens spherical face. The reason is that light refracting effect due to change of refractive index can be expected in addition to light refracting effect due to the lens effect. For example, when a viewing zone angle is made large in the same number of parallaxes, a focal length of a lens must be shortened or reduced. As a method for shortening a focal length of a lens, there are two kinds of methods. In a first method, even if a difference between projection and recess in lens shape is small, a focal length can be shortened by using material with a high refractive index as material for a lens and using material with a low refractive index, such as air, as medium coming in contact with the lens. In a second method, even if material for a lens with a large refractive index is not used, converging is achieved by reducing a radius of curvature of the lens and increasing a difference between recess and projection of the lens.

In the first method, since the difference between recess and projection of a lens is small, it is easy to produce the lens, but even if the lens is formed in an elliptical shape in order to reduce aberration, reduction is not achieved so much, because the difference is small. On the other hand, in the second method, since the difference between recess and projection of the lens is large, reduction of aberration achieved by forming a lens in an elliptical shape becomes larger than that in the first method. Therefore, since a focal length and a gap between a lens and a display are coincident with each other, a crosstalk amount on a display plane of the two-dimensional display device can be reduced regardless of whether a viewer is present at a center of a screen or at an end of the screen. However, there is such a problem that even if a radius of curvature is reduced in order to shorten a focal length of a lens extremely, converging can not be achieved due to a small difference in refractive index. In such a case, a process of using a biconvex lens to increase radius of curvatures of the biconvex lens instead of reducing the radius of curvature of the single-side convex lens is easily applied and when the radiuses of curvature of respective lens faces of the biconvex lens are set to the same, respective convex lenses of the biconvex lens can be produced using the same or one die, so that manufacturing cost is prevented from being increased significantly.

As one of the problems regarding production of a biconvex lens, there is necessity of positioning both convex lenses to each other and keeping a gap between the convex lenses constant. When hard material such as plastic or glass is used, a lens can be produced as designed, but since a gap between recess and projection in the lens may occur due to a difference in heat shrinkage or the like, the difference or the like must be reduced. When one of concave and convex lenses is produced using material whose shape changes freely such as liquid, a gap is prevented from occurring, but means for keeping a gap between both convex lenses constant must be adopted.

As a further problem, when a lens array is used as the beam controlling element for the stereoscopic image display apparatus, not only converging of light rays in a direction of an optical axis of a lens when the lens is viewed from its front face but also converging of light rays at a position deviated from an optical axis of the lens when the lens is viewed at a viewing zone angle θ must be taken into consideration. In case of the single-sided convex lens, light rays which have passed through a lens face do not pass through another lens face. In case of the biconvex lens, light rays which have passed through a lens face pass through another lens face. Light rays which have passed through lenses of the biconvex lens opposed to each other converges at a position of an elemental image (an image corresponding to each lens) on a flat display device as a designed value, but since light rays which have passed through an outer lens passes through a neighboring lens, a lens power to light rays at a lens end is reduced to ½, when a viewer views the light rays obliquely. Therefore, since light converges at a position different from a position of the elemental image, mixture of an image which is not an original parallax image is caused (hereinafter, called “stray light”). Since the above event injures or deteriorates a three-dimensional image display performance, any countermeasure must be taken.

As another problem, it is necessity of causing a center of a viewing zone to a central viewer in the stereoscopic image display apparatus. Therefore, it becomes important to position a lens on a viewer side and a lens on a two-dimensional device such that the centers of their optical axes are caused to coincide with each other. Unless the optical axes coincide with each other, there occurs such a problem that stray light increases.

### SUMMARY OF THE INVENTION

The present invention has been made in view of the above circumstances, and an object thereof is to provide a stereoscopic image display apparatus where a crosstalk amount and stray light are reduced even if a viewing zone angle is wide or large.

A stereoscopic image display apparatus according to a first aspect of the present invention includes:

a flat display device which has a display face including a plurality of pixels are arranged in a matrix manner; and

a beam controlling element which is provided on a front face of the flat display device and controls light rays from the pixels, the beam controlling element including
a first lens array which has a plurality of lenses, each lens having a face with a flat shape on a viewer side and a face with a recessed and projected shape on a flat display device side,
a second lens array which has a plurality of lenses, each lens having a face with a flat shape on the flat display device side and a face with a recessed and projected shape approximately equal to the recessed and projected shape of the first lens array in size on the viewer side, and
a third lens array which is provided between the first lens array and the second lens array and has a plurality of lenses, each lens having a face with a recessed and projected shape fitted to the recessed and projected shape in the first lens array on a first lens array side and with a face with a recessed and projected shape fitted to the recessed and projected shape in the second lens array on the second lens array, where a projection of each lens in the third lens array on the first lens array side corresponds to a projection of each lens in the third lens array on the second lens array side, and a recess of each lens in the third lens array on the first lens array corresponds to a recess of each lens in the third lens array on the second lens array side, wherein

the third lens array is configured such that each lens thereof on the first lens array side coincides with a corresponding lens thereof on the second lens array, and

refractive indexes of the first and second lens arrays are approximately the same, and a refractive index of the third lens array is different from the refractive indexes of the first and the second lens arrays.

Each of the first and second lens arrays can have a plurality of single-sided concave lenses and the third lens array can have a plurality of biconvex lenses.

The minimum lens thickness of each biconvex lens in the third lens array is represented as ds, a viewing zone angle is represented as 2θ, a lens pitch is represented as Iₚ, and a refractive index of the first lens array is represented as n, the biconvex lens can satisfy a relationship of
ds×sinθ/(Iₚ×n)<0.1.

The third lens array can be made of material whose shape changes freely.

The third lens array can be made of transparent solid material and the first and second lens arrays can be formed by stamping recesses and projections of the third lens array using silicon resin.

A stereoscopic image display apparatus according to a second aspect of the present invention includes:

a flat display device which has a display face including a plurality of pixels arranged in a matrix manner; and

a beam controlling element which is provided on a front face of the flat display device and controls light rays from the pixels including, the beam controlling element including;
a first lens array having a plurality of single-sided concave lenses, each lens having a face with a flat shape on a viewer side and a face with a concave lens shape on a flat display device,
a second lens array which has a plurality of single-sided concave lenses, each lens having a face with a flat shape on the flat display device side and a face with a concave lens shape approximately equal to the concave lens shape of the first lens array in size on the viewer side,
a transparent substrate which is provided between the first lens array and the second lens array,
a third lens array which is provided between the first lens array and the transparent substrate and has a plurality of single-sided convex lenses, each lens having a face with a convex lens shape fitted to the concave lens shape of the first lens array on a side of the first lens array and a face with a flat shape on a side of the transparent substrate, and
a fourth lens array which is provided between the transparent substrate and the second lens array and has a plurality of single-sided convex lenses, each lens having a face with a convex lens shape fitted to a concave lens shape of the second lens array and corresponding to a convex lens shape of the third lens array on a side of the second lens array and a face with a flat shape on a side of the transparent substrate, wherein

each single-sided convex lens of the third lens array is composed such that an optical axis thereof coincides with a corresponding single-sided convex lens of the fourth lens array, and

refractive indexes of the first and the second lens arrays are approximately the same, and the third and fourth lens arrays are higher in refractive index that the first and second lens arrays.

The third and fourth lens arrays can be made of material whose shape changes freely.

The third and fourth lens arrays can be made of material having a double refractive index.

The transparent substrate can be composed of first and second transparent substrates.

A beam controlling element according to a third aspect of the present invention includes:

a first lens array which has a plurality of lenses, each lens having a face with a flat shape on one side and a face with a recessed and projected shape on the other side,

a second lens array which has a plurality of lenses, each lens having a face with a flat shape on one side and a face with a recessed and projected shape approximately equal to the recessed and projected shape in the first lens array on the other side, and

a third lens array which is provided between the first lens array and the second lens array and has a plurality of lenses, each lens having a face with a recessed and projected shape fitted to the recessed and projected shape in the first lens array on a first lens array side and with a face with a recessed and projected shape fitted to the recessed and projected shape in the second lens array on the second lens array, where a projection of each lens in the third lens array on the first lens array side corresponds to a projection of each lens in the third lens array on the second lens array side, and a recess of each lens in the third lens array on the first lens array corresponds to a recess of each lens in the third lens array on the second lens array side,

wherein refractive indexes of the first and second lens arrays are approximately the same, and a refractive index of the third lens array is different from the refractive indexes of the first and the second lens arrays.

A beam controlling element according to a fourth aspect of the present invention includes:

a first lens array having a plurality of single-sided concave lenses, each lens having a face with a flat shape on one side and a face with a concave lens shape on the other side,

a second lens array which has a plurality of single-sided concave lenses, each lens having a face with a flat shape on one side and a face with a concave lens shape approximately equal to the concave lens shape in size on the other side,

a transparent substrate which is provided between the first lens array and the second lens array,

a third lens array which is provided between the first lens array and the transparent substrate and has a plurality of single-sided convex lenses, each lens having a face with a convex lens shape fitted to the concave lens shape of the first lens array on a side of the first lens array and a face with a flat shape on a side of the transparent substrate, and

a fourth lens array which is provided between the transparent substrate and the second lens array and has a plurality of single-sided convex lenses, each lens having a face with a convex lens shape fitted to a concave lens shape of the second lens array and corresponding to a convex lens shape of the third lens array on a side of the second lens array and a face with a flat shape on a side of the transparent substrate, wherein refractive indexes of the first and second lens arrays are approximately the same, and the third and fourth lens arrays are higher in refractive index that the first and second lens arrays.

Third lens array can be configured to arrange cylindrical lenses so that longitudinal axes of the cylindrical lenses are in parallel.

Each of the cylindrical lenses can have a birefringence index in which refractive index in a longitudinal axis direction is different from that in a lateral axis direction.

The refractive index in the lateral axis direction can be equal to one of the refractive indexes of the first and second lens arrays.

### BRIEF DESCRIPTION OF THE DRAWINGS

FIG. 1 is a horizontal sectional view of a stereoscopic image display apparatus according to a first embodiment of the present invention;

FIG. 2 is a diagram for explaining derivation of a focal length of a biconvex lens;

FIG. 3 is a schematic illustration of a lens viewed from top when lens material with the same refractive index is used in outer lenses and a radius of curvature r and a lens thickness d are changed in the first embodiment;

FIG. 4 is a schematic illustration of a lens viewed from top when lens material with the same refractive index is used in outer lenses and a radius of curvature r and a lens thickness d are changed in the first embodiment;

FIG. 5 is a schematic illustration of a lens viewed from top when lens material with the same refractive index is used in outer lenses and a radius of curvature r and a lens thickness d are changed in the first embodiment;

FIG. 6 is a graph showing a relationship among d, ds, and r obtained by optimization of a lens shape in the first embodiment;

FIG. 7 is a locus diagram of light rays for explaining a stray light region in the first embodiment;

FIG. 8 is a view showing an example where a lens shape is an elliptical shape in the first embodiment;

FIG. 9 is a graph showing a viewing zone angle dependencies of a ratio of a stray light region when a value of ds is 0 μm, 0.187μm and 0.414μm;

FIG. 10 is a graph showing viewing zone angle dependencies of crosstalk amounts of single-sided convex lenses and a biconvex lens obtained when optimization is achieved by a lens simulator;

FIG. 11 is a view showing a case that a single-sided convex lens is used as an beam controlling element in a stereoscopic image display apparatus;

FIG. 12 is a view showing a case that a biconvex lens is used as an beam controlling element in a stereoscopic image display apparatus;

FIG. 13 is a view showing another specific example of a lens array according to the first embodiment;

FIG. 14 is a horizontal sectional view of a stereoscopic image display apparatus according to a second embodiment of the present invention;

FIG. 15 is a graph showing the result of simulation for a crosstalk amount performed while a refractive index of a central transparent substrate is being changed in the second embodiment;

FIG. 16 is a horizontal sectional view of a stereoscopic image display apparatus according to a first modification of the second embodiment;

FIG. 17 is a horizontal sectional view of a stereoscopic image display apparatus according to a second modification of the second embodiment;

FIG. 18 is a schematic diagram for explaining a case where a polarization plane has been changed by 900 in the liquid crystal display device;

FIG. 19 is a schematic diagram for explaining a case where the polarization plane is not changed in the liquid crystal display device;

FIG. 20 is a diagram for explaining a polarization plane in a three-dimensional display mode in the second embodiment;

FIG. 21 is a diagram for explaining a polarization plane in a two-dimensional display mode in the second embodiment;

FIG. 22 is a diagram for explaining a polarization plane in the three-dimensional display mode in the second embodiment;

FIG. 23 a diagram for explaining a polarization plane in the two-dimensional display mode in the second embodiment;

FIG. 24 is a diagram showing a birefringent film in the second embodiment;

FIG. 25 is a diagram for explaining a process for stamping a birefringent film to a biconvex lens in the second embodiment;

FIG. 26 is a perspective view of the biconvex lens after stamped to a second lens in the second embodiment;

FIG. 27 is a view of a product obtained by attaching the second lens with first and third lenses in the second embodiment;

FIG. 28 is a diagram for explaining a process for stamping a half of the second lens in the second embodiment;

FIG. 29 is a diagram for explaining a process for producing a column with a birefringence;

FIG. 30 is a diagram for explaining a process for arranging the birefringent columns shown in FIG. 29 laterally to produce a lens array thereof; and

FIG. 31 is a diagram of a product obtained by attaching a birefringent column lens array produced according to the process shown in FIG. 30 with first and third lenses.

### DETAILED DESCRIPTION OF THE INVENTION

Embodiments of the present invention will be explained below in detail with reference to the drawings.

### First Embodiment

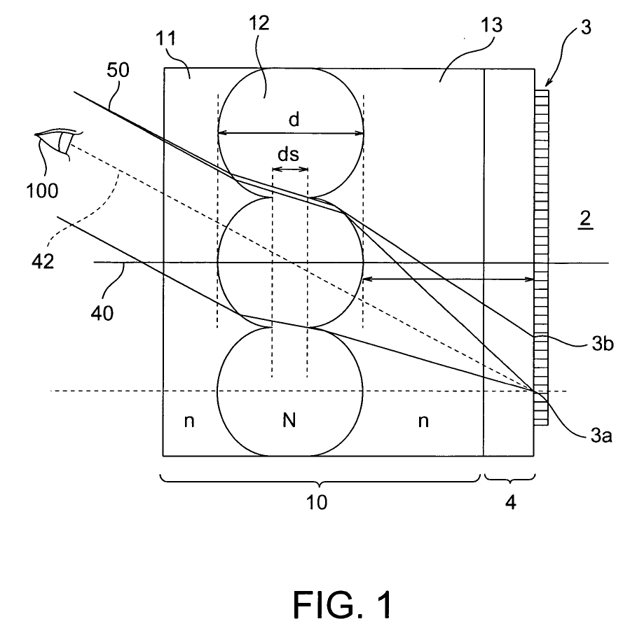

A stereoscopic image display apparatus according to a first embodiment of the present invention will be explained with reference to FIG. 1 to FIG. 12. FIG. 1 is a horizontal sectional view of a stereoscopic image display apparatus according to the embodiment.

A stereoscopic image display apparatus according to the embodiment is provided with a flat display device (also, called “a two-dimensional display device) 2 and a beam controlling element 10. The flat display device 2 is a liquid crystal display device, for example, and it is provided with a display portion 3 for displaying image information which has a plurality of pixels arranged in a matrix manner, and a protection substrate 4 for protecting the display portion 3 which is composed of a transparent member, for example, a glass.

The beam controlling element 10 is disposed on a front face of the flat display device 2 (on a side of a viewer 100) and is provided with a lens array 11, a lens array 12, and a lens array 13. The lens array 11 includes a plurality of single-sided concave lenses, each having a flat shape on the viewer 100 side and having a concave lens shape on the flat display device 2 side. Each single-sided concave lens extents in a vertical direction (in a direction orthogonal to a drawing sheet for FIG. 1) on a screen of the flat display device 2. The lens array 13 is provided nearer to the flat display device 2 than the lens array 11, and it includes a plurality of single-sided concave lenses, each having a flat shape on the flat display device 2 and a concave lens shape on the viewer 100 side, which are arranged to correspond to the plurality of single-sided concave lens of the lens array 11. Each single-sided concave lens extents in the vertical direction (in a direction orthogonal to the drawing sheet for FIG. 1) on the screen of the flat display device 2. The concave lens shape of each single-sided concave lens in the lens array 11 is approximately the same as that of each single-sided concave lens in the lens array 13. Such an arrangement is adopted that an optical axis of each single-sided concave lens in the lens array 11 and an optical axis of a corresponding concave lens in the lens array 13 are substantially coincident with each other. The lens array 12 is provided between the lens array 11 and the lens array 13, and it has a plurality of biconvex lenses, each having a convex lens shape on the viewer 100 side and a convex lens shape on the flat display device 2 side. Each biconvex lens extents in the vertical direction (in a direction orthogonal to the drawing sheet for FIG. 1) on the screen of the flat display device 2. Respective convex lenses of the biconvex lens in the lens array 12 are formed so as to be fitted to the concave lenses of the lens array 11 and the lens array 13. In the embodiment, the lens array 11 and the lens array 13 have approximately the same refractive index, but the lens array 12 is different in refractive index from the lens arrays 11 and 13.

In FIG. 1, reference numeral 40 denotes an optical axis of each lens, and reference numeral 42 denotes a locus of a light ray entering in an eye of the viewer 100. Reference numeral 3a denotes a position of a correct elemental image (a set of images allocated to (corresponding to) one lens), reference numeral 3b denotes a position of a wrong elemental image, and reference numeral 50 denotes a stray light region.

Next, conditions for reduction in stray light and crosstalk amount in the stereoscopic image display apparatus of the embodiment composed in the above manner will be explained.

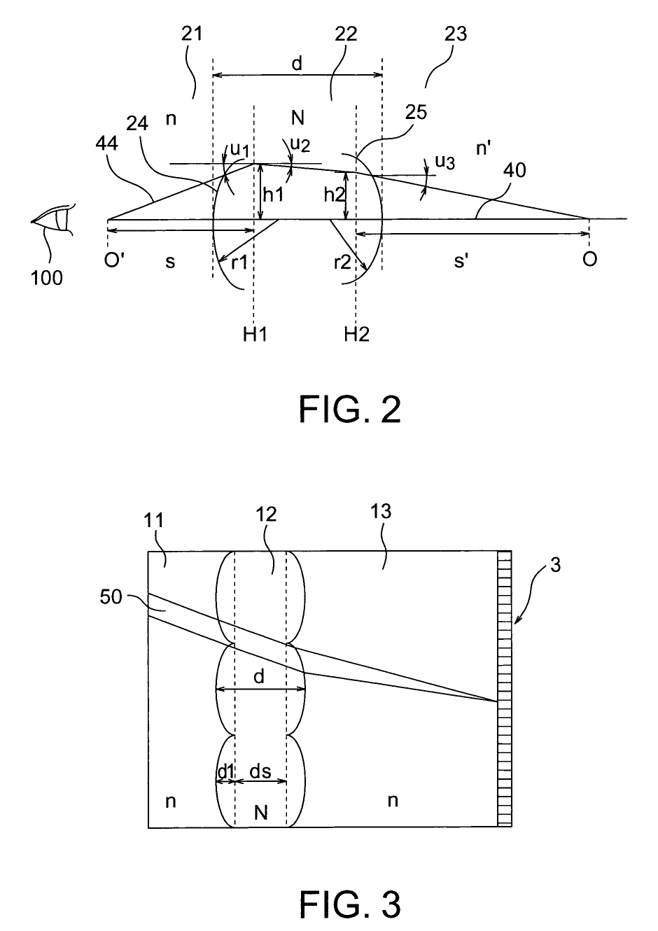

A focal length of a biconvex lens is derived with reference to FIG. 2. FIG. 2 is a diagram showing a locus of a light ray which passes through a biconvex lens having two kinds of lens curved faces 24 and 25. The biconvex lens is formed from a medium 22 with a refractive index N, and a medium 21 with a refractive index of n is positioned on the viewer 100 side and a medium 23 with a refractive index of n′ is positioned on an opposite side of the viewer 100.

In FIG. 2, u₁, u₂, and u₃ denote incident angles on the mediums 21, 22, and 23 having the refractive indexes n, N, and n′ respectively, to the optical axis 40. Reference signs H1 and H 2 denote a principal point on an object side and a principal point on image side. Reference signs h1 and h2 denote heights from the optical axis 40 when a light ray 44 enters on a lens face 24 and when it enters on a lens face 25. Reference signs r1 and r2 denote radiuses of curvature of the lens faces 24 and 25. A focal length f denotes a distance between the principal point when parallel rays enter in the lens from the viewer 100 side in FIG. 2 and the local point, which corresponds to a distance s′ between the image side principal point H2 and the focal point O. Reference sign d denotes a distance between the thickest portions of the convex lenses, or a lens thickness of the biconvex lens.

The following relationship is derived from FIG. 2.

$${Nu}_{2} = {nu}_{1} + ( \frac{N - n}{r 1} ) h 1$$

$${n}^{′} {u}_{3} = {Nu}_{2} + ( \frac{{n}^{′} - N}{r 2} ) h 2$$

$$h 2 = h 1 - {du}_{2}$$

From the above equations, the following Equation (1) can be obtained.

$$\begin{matrix}{n}^{′} {u}_{3} = n \{ 1 - \frac{d}{N} ( \frac{{n}^{′} - N}{r 2} ) \} u 1 + \{ ( \frac{N - n}{r 1} + \frac{{n}^{′} - N}{r 2} ) - \\ \frac{d}{N} ( \frac{N - n}{r 1} ) ( \frac{{n}^{′} - N}{r 2} ) \} h 1 \frac{1}{f} \\ = \frac{{u}_{3}}{h 1} ( at {u}_{1} = 0 ) \\ = \frac{1}{{n}^{′}} \{ ( \frac{N - n}{r 1} + \frac{{n}^{′} - N}{r 2} ) - \frac{d}{N} ( \frac{N - n}{r 1} ) ( \frac{{n}^{′} - N}{r 2} ) \}\end{matrix} \qquad ( 1 )$$

It is understood from the Equation (1) that, assuming that the focal length f is fixed, there is a relationship among differences in refractive index between the biconvex lens 22 and the mediums 21 and 23, the radiuses of curvature r1, r2, and the lens thickness d.

In general, assuming that a focal length is fixed, in one of mediums coming in contact with a lens face which has a smaller refractive index, a radius of curvature of a lens curved face becomes short, so that projection and recess of a lens becomes large. In that case, by adopting an elliptical shape as a lens shape, aberration can be reduced. Therefore, a difference in refractive index is here set to such a small value as 0.1 in view of such a merit that an elliptical shape is easily adopted. When switching between a two-dimensional image display mode and a three-dimensional image display mode is adopted, it is effective to obtain a relationship between the lens thickness and the radius of curvature in a small difference in refractive index, since an ordinary liquid crystal has a small difference in refractive index such as a value in a range of 0.1 to 0.2.

In Equation (1), setting is performed in view of easiness in manufacture that the radiuses of curvatures r1 and r2 of the biconvex lens are the same and the refractive index n of the outermost (the viewer 100 side) medium 21 and the refractive index n′ of the innermost (the opposite side of the viewer 100) medium 23 are the same. With such setting, the following Equations (2) and (3) are derived from Equation (1).

$$\begin{matrix}\frac{1}{f} = \frac{( N - n )}{rn} ( 2 - \frac{( N - n ) d}{Nr} ) & ( 2 ) \\ d = \frac{Nr}{( N - n )} ( 2 - \frac{rn}{f ( N - n )} ) & ( 3 )\end{matrix}$$

In Equation (3), since the lens thickness d is a second-order function of the radius of curvature r of the lens, it has an extreme value. In fact, since it is assumed that a lens curved face is a spherical face in Equation (3), when an elliptical shape is used as the lens curved face in order to reduce aberration of the lens, the lens thickness d does not accord with Equation (3) correctly but a tendency thereof approximately coincide with that of Equation (3).

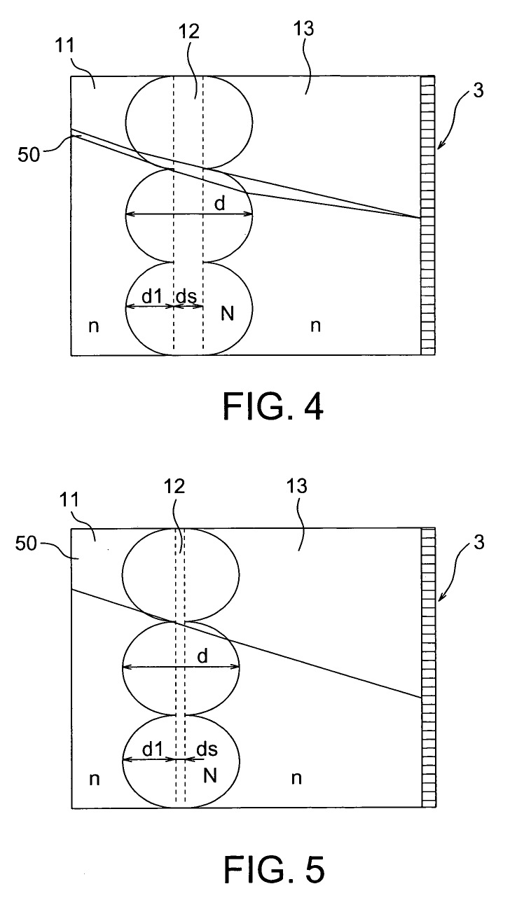

Next, optimization of a lens shape with an elliptical shape is performed using an optical simulator. When three kinds of lenses 11, 12, and 13 with the same focal point are provided commonly in respective examples in this embodiment, plan lens illustrations when lens material with the same refractive index is used for the lenses 11 and 13 and the radius of curvature r and the lens thickness d are changed are shown in FIG. 3, FIG. 4, and FIG. 5. In FIGS. 3 to 5, a thickness of the thickest portion of a biconvex lens is represented as d, a distance between the thinnest portions of respective lens of the biconvex lens is represented as ds, and a difference between projection and recess of each lens is represented as dl.

FIG. 3 is a view showing an example of a lens where the radius of curvature r is set to the maximum. In the example shown in FIG. 3, since dl is small but ds is large, a total thickness d becomes large. In FIG. 3, it is understood in this manner that, since ds is large, a stray light region 50 becomes wide or large. FIG. 4 is a view showing an example of a lens where the radius of curvature r is slightly reduced as compared with that of the lens shown in FIG. 3. In the example shown in FIG. 4, a power for bending a light ray at a lens face becomes large due to reduction in radius of curvature r. In the example shown in FIG. 4, therefore, ds becomes small and the total thickness d also becomes small. In the example shown in FIG. 4, it is understood that the stray light region 50 also becomes narrow or small due to reduction in ds. Finally, FIG. 5 is a view showing an example of a lens where the radius of curvature r is set to the minimum. In the example shown in FIG. 5, since d1 becomes large but ds becomes the smallest, the total thickness d becomes large again. In the example shown in FIG. 5, therefore, it can be said that there is hardly a stray light region 50.

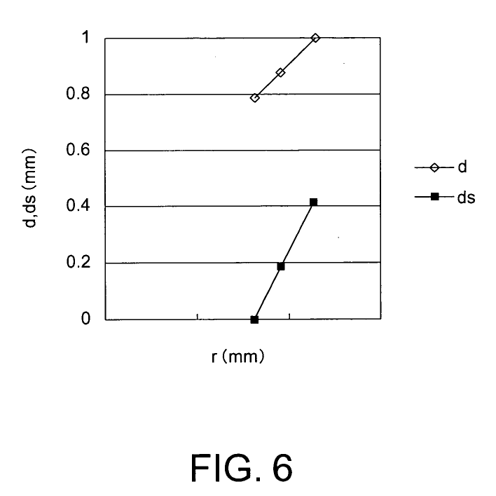

A relationship among d, ds and r obtained according to the optimization of the lens shape is shown in FIG. 6. In FIG. 6, values of an ordinary plastic lens are used as refractive indexes n and N, and a difference in refractive index Δn (=N−n)=0.1 is set. It is understood from FIG. 6 that thicknesses d and ds of a biconvex lens become large (thicker) according to increase in radius of curvature r.

From the above explanation, it is understood that ds should be reduced in order to make the stray light region 50 narrow. In the embodiment, therefore, the condition that a ratio of the stray light region 50 to the elemental image region is 10% or less will be explained as a target.

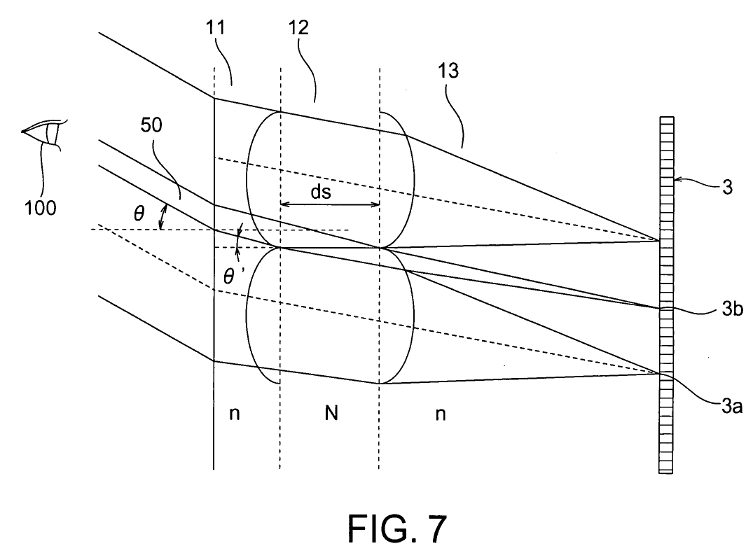

In FIG. 7, in case that a viewing zone angle is 2θ in a stereoscopic image display apparatus, when a lens pitch is represented as Iₚ and a refractive index of a concave lens 11 nearest to the viewer 100 in FIG. 7 is represented as n, and a ratio of a stray light region 50 to an elemental image is represented as m, the following Equations (4), (5), and (6) are obtained.
sinθ=nsinθ′ (4)
m=ds×sinθ′/Iₚ<0.1 (5)
m=ds×sinθ/(Ip×n)<0.1 (6)

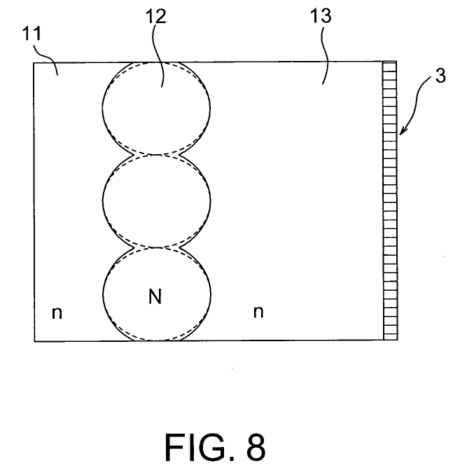

Incidentally, in FIG. 7, since the protection substrate 4 shown in FIG. 1 has the substantially same refractive index as the lens 13, it is included in the lens 13. As expressed in Equation (2), for a spherical lens, ds can be obtained, if the lens thickness d, the radius of curvature r, and the lens pitch Iₚ are determined. The lens shape can be formed so as to satisfy Equation (6). Equations (4) to (6) are satisfied when the lens has a spherical shape and when it has an elliptical shape. Incidentally, FIG. 8 shows an example where the lens has the elliptical shape. In FIG. 8, a case that the biconvex lens 12 has an elliptical shape is shown by a solid line and a case that the biconvex lines 12 has a spherical shape is shown by a broken line.

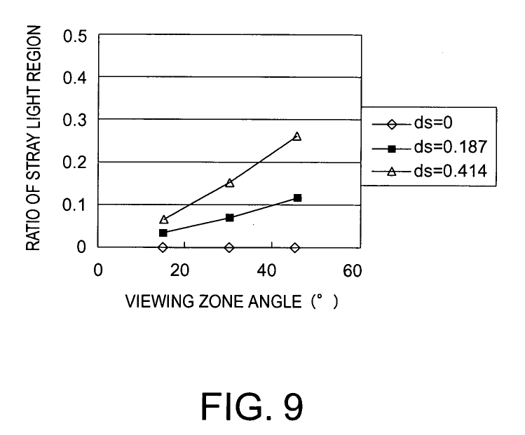

Viewing zone angle dependencies of the ratio m of a stray light region to an elemental image when values of ds are 0 μm, 0.187 μm, and 0.414 μm are shown in FIG. 9. It is understood from FIG. 9 that the ratio m of the stray light region 50 can be reduced to 10% or less in a range of a viewing zone angle of 45° or less when the value of ds is 0.187 μm or less.

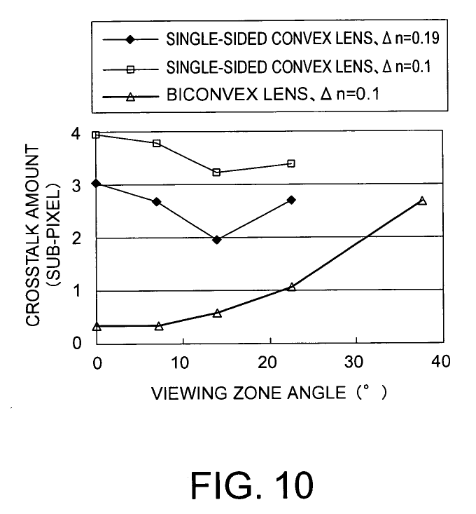

Viewing zone angle dependencies θ of crosstalk amounts of single-sided lenses and a biconvex lens obtained when optimization has been achieved by the lens simulator are shown in FIG. 10. Here, the crosstalk amount means standardization of a range where light rays are condensed on a two-dimensional display device by a lens utilizing a pixel width (sub-pixel width). Since the viewing zone angle θ is an angle from a vertical line to a screen, a total viewing angle composed of the viewing zone angle on a left side to the vertical line and the viewing zone angle on a right side thereto is represented as 2θ. In FIG. 10, for example, it means mixing of three pixel information elements into parallax light rays at a certain angle that the crosstalk amount is 3. Increase of the crosstalk amount causes such display degradation as burr on a three-dimensional image display or a double image.

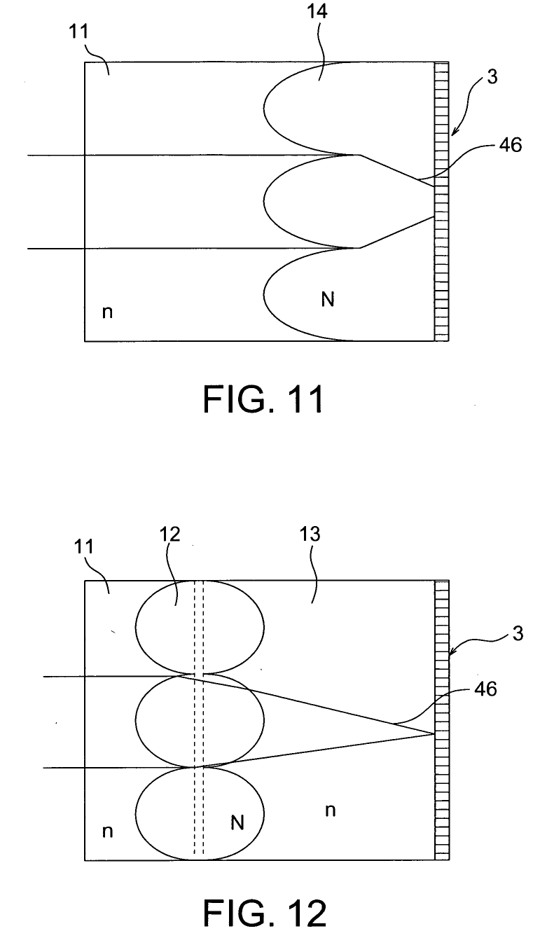

As understood from FIG. 10, in case of the difference in refractive index Δn (=N−n)=0.1 in a single-sided lens, the crosstalk amount increases to 4 or more due to shortage of lens power. In case of the difference in refractive index An (=N−n)=0.19 in a single-sided lens, the lens power increases, but the crosstalk amount is large such as 2 or more and the crosstalk amount at a viewing zone angle of 0 is 3. Thus, since the crosstalk amount at the viewing zone angle of 0 is large, it is seemed that degradation is conspicuous. In case of the difference in refractive index Δn (=N−n)=0.1 in a biconvex lens, since the crosstalk amount is suppressed to 2 at a viewing zone angle θ of 30° or less, degradation on the three-dimensional image display is small. Incidentally, an example of the single-sided lens is shown in FIG. 11, and an example of the biconvex lens is shown in FIG. 12. In FIG. 11, reference numeral 14 denotes a single-side convex lens. In FIGS. 11 and 12, reference numeral 46 denotes a locus of parallel light rays when the light rays along an optical axis enter in each lens.

As explained above, according to the embodiment, even if the viewing zone angle is wide or large, the crosstalk amount and stray light can be reduced.

Next, an actual method for producing the lens arrays 11, 12, and 13 according to the embodiment will be explained.

In one method, a biconvex lens surrounded by a flat face can be produced by manufacturing molds for three kinds of lens arrays 11, 12, and 13 and producing three kinds of plastic lenses to combine them.

As another method, there is a method where silicon rubber is used. In the method, instead of producing all the lenses using plastic, only a central lens array 12 is formed from plastic in a predetermined shape with a high accuracy, and a lens array 11 on the viewer 100 side and a lens array 13 on the two-dimensional display device 2 are molded using silicon rubber. In this method, the lens arrays 11, 12, and 13 can be inexpensively combined without any gap. As the silicon rubber, transparent one is used. When the lens arrays 11 and 13 are molded using silicon rubber, two-solution type material is used as far as possible and silicon rubber is solidified at a temperature lower than an allowable temperature limit of the central plastic lens 12.

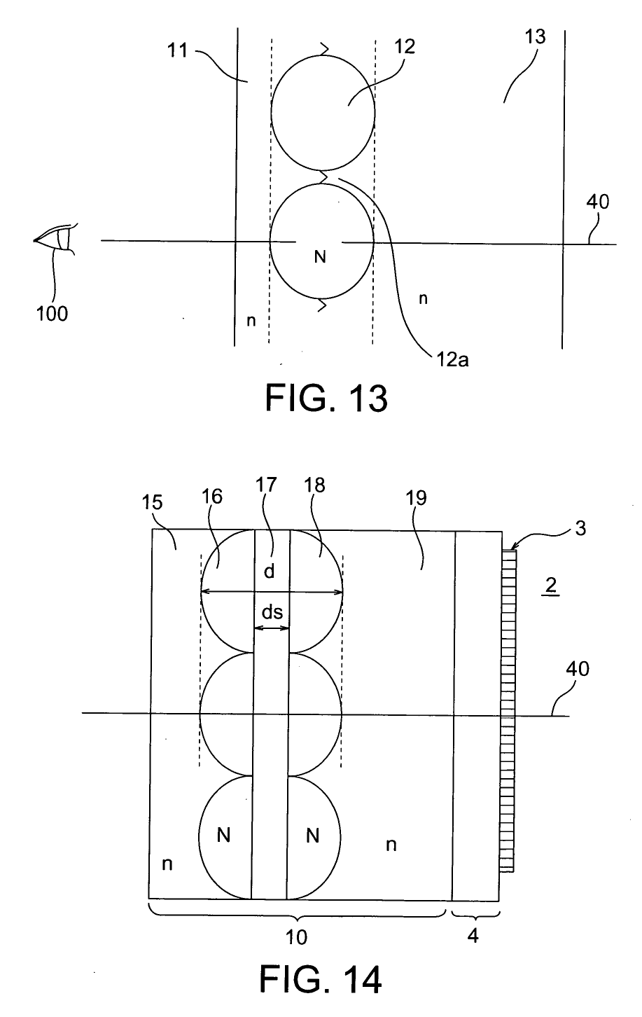

Another specific example of lenses arrays 11, 12, and 13 according to the embodiment will be explained with reference to FIG. 13. In the specific example shown in FIG. 13, of three kinds of lens arrays 11, 12, and 13, the lens array 11 positioned on the viewer 100 side and the lens array 13 positioned on the two-dimensional display device are formed from plastic lens and a central lens array 12 is formed by filling of material whose shape is freely deformable such as liquid, so that a combination lens is produced. In the biconvex lens thus formed, a stray light region can be reduced to the minimum by causing respective lens to coincide with one another. Therefore, a recess and a projection are provided at a portion 12a connecting the convex lens 11 on the viewer side and the lens 13 on the two-dimensional display device side in order to facilitate positioning. By providing the recess and projection in this manner, positioning with a high accuracy can be achieved according to self-alignment.

### Second Embodiment

Next, a stereoscopic image display apparatus according to a second embodiment of the invention will be explained with reference to FIGS. 14 to 23. FIG. 14 is a horizontal sectional view of a stereoscopic image display apparatus according to the embodiment.

A stereoscopic image display apparatus according to the embodiment is provided with a flat display device (also, called “a two-dimensional display device) 2 and an beam controlling element or a beam controlling element 10. The flat display device 2 is a liquid crystal display device, for example, and it is provided with a display portion 3 for displaying image information which has a plurality of pixels arranged in a matrix manner, and a protection substrate 4 for protecting the display portion 3 which is composed of a transparent member, for example, a glass.

The beam controlling element 10 is provided on a front face of the flat display device 2, and it is provided with lens arrays 15, 16, a transparent substrate 17, and lens arrays 18, 19 arranged in this order from a viewer side. The lens array 15 has a plurality of single-sided concave lenses, each having a flat shape on the viewer side and a concave lens shape on the flat display device 2 side. Each single-sided concave lens extents in a vertical direction (in a direction orthogonal to a drawing sheet for FIG. 14) on a screen of the flat display device 2. The lens array 19 is provided nearest to the flat display device 2 side, and it includes a plurality of single-sided concave lenses, each having a flat shape on the flat display device 2 and a concave lens shape on the viewer side, which are arranged to correspond to the plurality of single-sided concave lens of the lens array 15. Each single-sided concave lens extents in the vertical direction (in the direction orthogonal to a drawing sheet for FIG. 14) on the screen of the flat display device 2. The concave lens shape of each single-sided concave lens in the lens array 15 is approximately the same as that of each single-sided concave lens in the lens array 19, and such an arrangement is adopted that optical axes 40 of single-sided lenses in the lens arrays 15 and 19 corresponding to each other approximately coincide with each other. The transparent substrate 17 is composed of a transparent member with flat shapes on the viewer side and on the flat display side which has a width of ds, and it is provided between the lens array 15 and the lens array 19 so as to come in contact with the lens array 16 and the lens array 18. The lens array 16 is formed with substance whose shape can be freely deformable, for example, liquid or liquid crystal, which is filled between a recessed portion of the single-sided concave lens of the lens array 15 and a flat face of the transparent substrate 17. The lens array 18 is formed with substance whose shape can be freely deformable, for example, liquid or liquid crystal, which is filled between a recessed portion of the single-sided concave lens of the lens array 19 and another flat face of the transparent substrate 17. Substance for forming the lens array 16 and the lens array 18 has a refractive index higher than that of substance for forming the lens arrays 15, 19.

In the embodiment, an example where birefringent material such as liquid crystal is used as material for both the lens arrays 16, 18 will be explained. The liquid crystal is poured in a space between glass substrates having a thickness or size of several micron meters in general, and liquid crystal molecules are aligned according to orientation films on both sides. The liquid crystal molecules maintain orientations at the interface with the glass substrates, so that liquid crystal molecules can be aligned while maintaining an order over the whole liquid crystal. Here, three problems occur.

When the thickness (hereinafter, called “gap”) between glass substrates is increased to several hundreds micron meters, oritentation is obtained only at the interface between liquid crystal and the glass substrates, and orientations of the entire liquid crystal are disordered so that in-plane fluctuation of a refractive index may occur. It is necessary to control a distance between both convex lenses precisely in view of optical characteristics. When an outer concave lens 15 and an inner concave lens 19 are produced and a center or a gap therebetween is filled with liquid crystal, a shape of liquid crystal freely deform in the center portion or gap in the constitution shown in FIG. 1, so that it is difficult to accommodate the gap over the entire lens.

As shown in FIG. 14, therefore, the following three merits can be obtained by placing a transparent substrate 17 between the concave lenses.

The gap can be controlled by bringing projections of the concave lenses 15 and 19 in contact with the transparent substrate 17.

(2) The gap can be set to half the lens thickness or less by producing an orientation film of liquid crystal on a thin transparent substrate 17, which results in easiness of arrangement of liquid crystal molecules in the same or one direction.

(3) Since the thin transparent substrate 17 has not any curved face and has no lens effect, a refractive index of the transparent substrate 17 can be selected arbitrarily. Therefore, an orientation film process is stable, and a hard glass substrate having reduced water absorption coefficient and easy flat face formation can be used. A plastic film which is poor in reliability but inexpensive can be used, and the degree of freedom is improved.

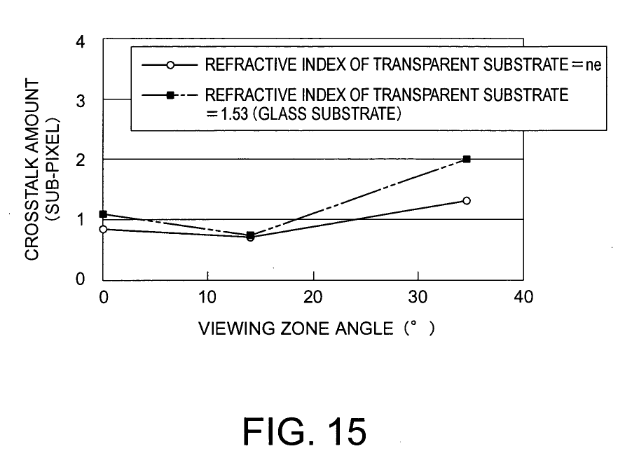

In the above item (3), a result obtained by simulating a crosstalk amount in different refractive indexes of the central transparent substrate 17 is shown in FIG. 15. FIG. 15 shows lens simulation results obtained when a refractive index of the transparent substrate 17 is caused to coincide with those of the lens array 16 and the lens array 18 which are contents in the concave lenses 15 and 19 and obtained when a material with a different refractive index, specifically, a glass substrate, is used. It is understood from FIG. 15 that there is not so much difference between both the cases and the both are not so different in three-dimensional image display performance from each other.

As explained above, according to the embodiment, when a large or wide viewing zone angle is adopted, the crosstalk amount and the stray lights can be reduced.

Next, modification of the embodiment for facilitating positioning of lenses on the viewer side and the two-dimensional display device side will be explained.

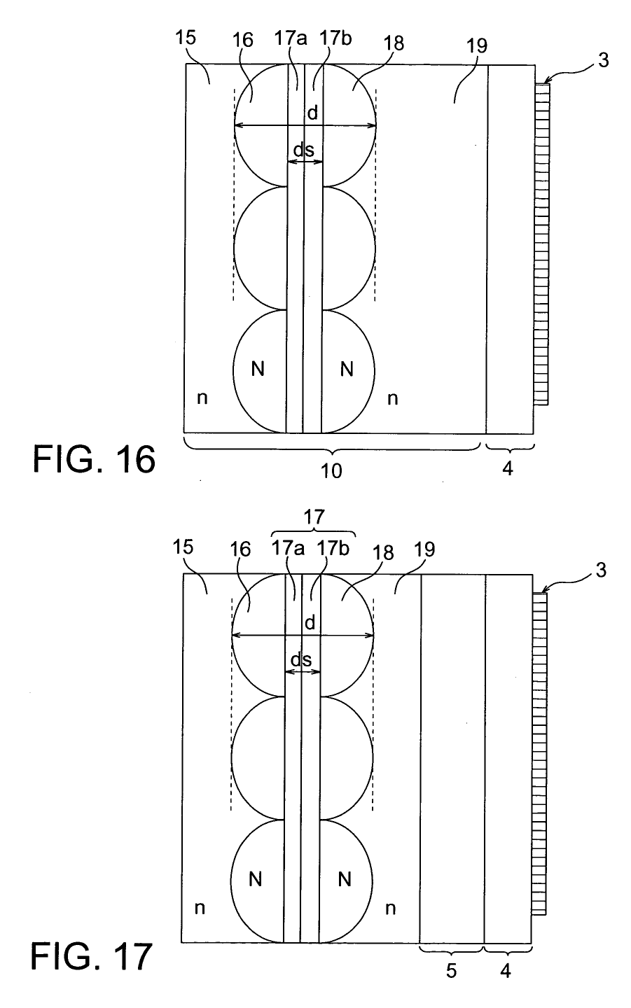

A method for causing optical axes 40 of the concave lens 15 on the viewer side and the concave lens 19 on the two-dimensional display device which sandwiches the thin transparent substrate 17 to coincide with each other will be described first. As one method, there is a method where positioning marks are attached between the lenses 15 and 19, and the transparent substrate 17 and the concave lenses 15 and 19 are bonded to both sides of the transparent substrate 17 in such a state that the lenses 15 and 19, and the transparent substrate 17 have been caused to coincide with each other. In the method, since lens material is not in recesses of the concave lenses 15 and 19, positioning can not be performed using an image. As shown in FIG. 16, therefore, such a constitution may be adopted that two thin transparent substrates 17a and 17b are used as the transparent substrate and a member obtained by bonding the concave lens 15 on the viewer side and the transparent substrate 17a and a member obtained by bonding the concave lens 19 and the transparent substrate 17b are produced individually. A manufacturing method applied to this case will be explained below.

Steps of bonding the concave lens 15 on the viewer side and the transparent substrate 17a to each other, pouring liquid crystal, and sealing the liquid crystal are first terminated. Next, steps of bonding the concave lens 19 on the two-dimensional display device and the transparent substrate 17b to each other, pouring liquid crystal, and sealing the liquid crystal are terminated. At that time, the liquid crystals of the lenses on the viewer side and the two-dimensional display device are put in oriented state. Therefore, positioning can be conducted precisely while a test image during a three-dimensional image display mode is being observed.

Since a thickness of the concave lens 15 on the viewer side is independent of the focal length, there is a demand that the concave lens 15 should have a strength to a certain extent and should be made thinner in order to reduce warpage of a lens due to heat. It is necessary to cause the thickness of the concave lens 19 on the two-dimensional display device to match with the focal length. Therefore, such a case often takes place that the lens 15 on the viewer side and the lens 19 on the two-dimensional display device are different in thickness. Since two kinds of lens must be produced in the case, manufacturing cost rises. There is a possibility that three-dimensional image display deteriorates due to a difference in deformation due to heat between the two kinds of lenses. As shown in FIG. 17, therefore, manufacturing cost and reliability can be improved by setting the lenses on the viewer side and the two-dimensional display device to the same thickness and adjusting the thickness utilizing a glass substrate 5.

Next, conditions of the refractive indexes of lenses when conversion between a two-dimensional image and a three-dimensional image is performed will be explained. When a refractive index in a long axis direction is represented as ne and a refractive index in a short axis direction is no, there are many liquid crystals where a difference in refractive index (ne−no)=Δn is not zero. For example, when liquid crystal where the difference in refractive index Δn is positive is used, unless the refractive index N of a liquid crystal lens is larger than a refractive index n of a concave lens on the viewer side or the two-dimensional display device in the constitution shown in FIG. 14, 16, or 17, light rays can not be condensed in the three-dimensional image display. Therefore, it is necessary to change a polarization plane such that ne which is the larger refractive index of liquid crystal is developed during the three-dimensional image display mode.

Next, it is necessary to change the polarization plane such that no which is the smaller refractive index of liquid crystal is developed during the two-dimensional image display mode. Here, when the refractive indexes n and no of the concave lenses on the viewer side and the two-dimensional display device are substantially the same, an excellent two-dimensional image display mode can be realized without causing converging of light rays. In order to realize the above, it is desirable that a rubbing direction of an orientation film is parallel to a line connecting the centers of the concave lenses.

As described above, change of the polarization plane of liquid crystal between the three-dimensional image display mode and the two-dimensional image display mode will be explained.

Units for changing a polarization plane are roughly classified to a case that each unit is disposed between the two-dimensional display device 2 and the beam controlling element 10 composed of combined lenses and a case that it is disposed between the beam controlling element 10 and the viewer side.

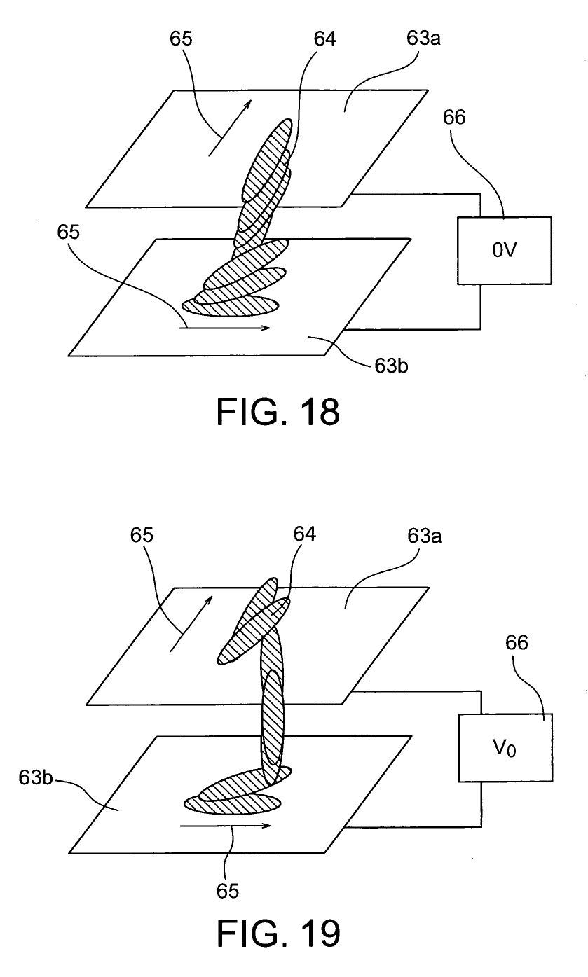

For example, one example of a unit for changing a polarization plane by an angle of 90° is shown in FIGS. 18 and 19. In FIGS. 18 and 19, a rubbing direction 65 is determined such that orientation faces of glass substrates 63a and 63b are rotated to each other by an angle of 90°, so that rubbing is performed. FIG. 18 shows a case that a voltage is not applied between the glass substrates 63a and 63b by a voltage controller 66, where a polarization plane is rotated by an angle of 90°. FIG. 19 shows a case that a voltage is applied between the glass substrates 63a and 63b by the voltage controller 66, where liquid crystal 64 becomes perpendicular to the glass substrates 63a and 63b so that the polarization plane is not rotated.

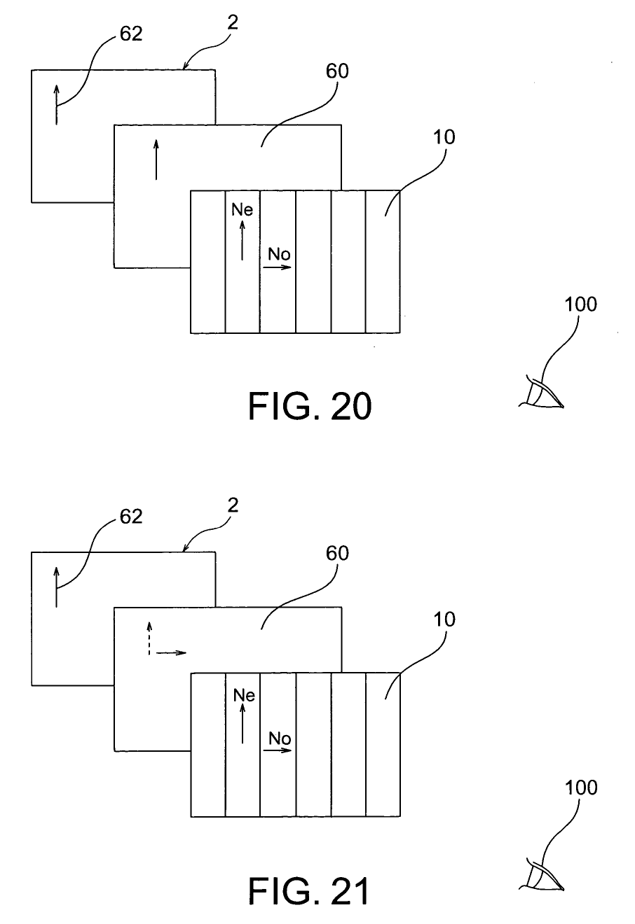

FIG. 20 and FIG. 21 show a case that a unit 60 for controlling a polarization plane is disposed between the two-dimensional display device 2 and the beam controlling element 10 composed of combined lenses. FIG. 20 shows a three-dimensional image display mode. For example, when a polarization plane 62 of the liquid crystal display device 2 is set to be parallel to a long axis direction Ne of liquid crystal molecules and the polarization plane 62 is not rotated angle of 90°, that is, the state shown in FIG. 19 is utilized, the polarization plane 62 becomes parallel so that the three-dimensional image display mode is developed.

FIG. 21 shows a two-dimensional image display mode. When the polarization plane 62 is rotated an angle of 90°, that is, when the state shown in FIG. 18 is utilized, the polarization plane 62 becomes parallel to the refractive index No in the short axis direction of liquid crystal molecules, so that the two-dimensional image display mode is developed. When the unit 60 for controlling a polarization plane is disposed between the two-dimensional display device 2 and the beam controlling element 10 composed of combined lenses, it is necessary to cause a distance between a combined lens plane and a pixel plane of the two-dimensional display device 2 to coincide with the focal length. Therefore, glass substrates sandwiching liquid crystal 64 shown in FIGS. 18 and 19 must be made thinner by utilizing a process for polishing the glass substrates or the like.

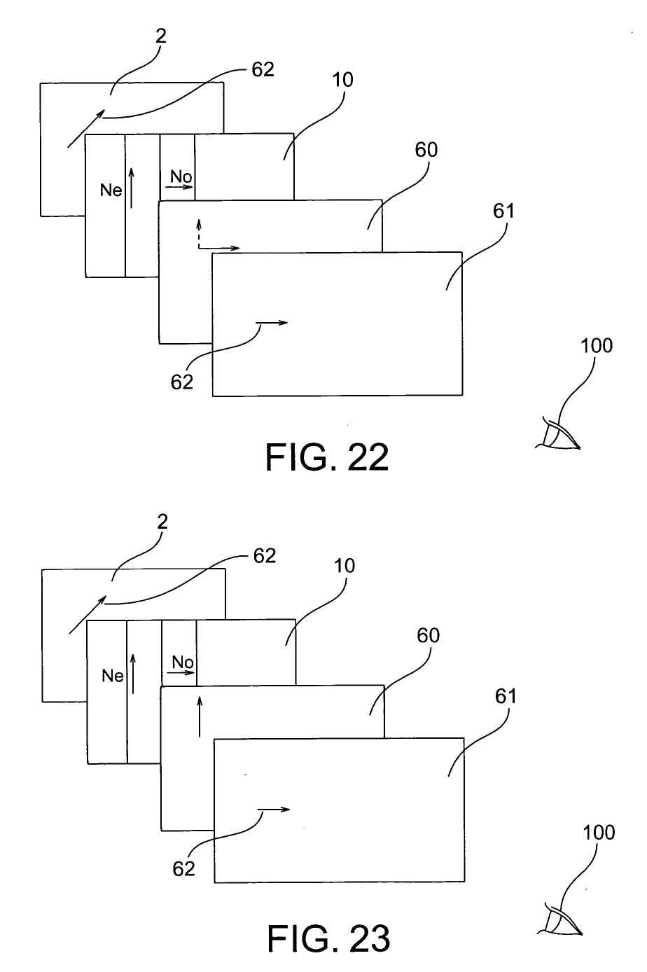

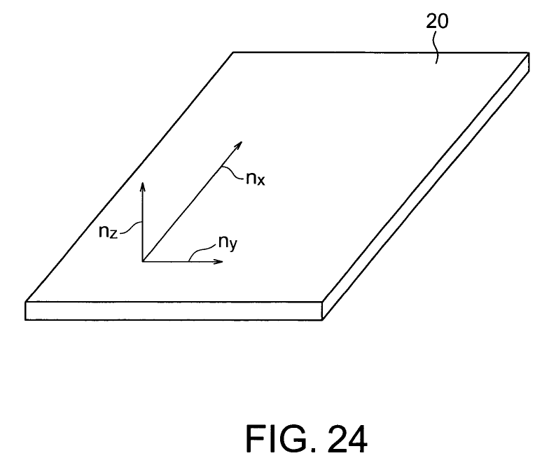

FIG. 22 and FIG. 23 show a case that the unit 60 for controlling a polarization plane is disposed between the beam controlling element 10 composed of combined lenses and the viewer 100 side. FIG. 22 shows a three-dimensional image display mode, where the polarization plane 62 of the two-dimensional display device 2 is aligned in a direction where the long axis direction Ne and the short axis direction No have been rotated to each other by an angle of 45°. Further, an image with the same brightness in both directions of the short axis direction Ne and the short axis direction No of liquid crystal molecules passes owing the beam controlling element 10 composed of combined lenses. FIG. 23 shows a three-dimensional image display mode. In that case, since the polarization plane 62 is rotated by an angle of 90°, only light in the long axis direction Ne of liquid crystal molecules can be observed by the viewer by the uppermost polarization plate 61. In the two-dimensional image display mode, the polarization plane 62 is not subjected to 90° rotation. Only light rays parallel to the short axis direction No of liquid crystal molecules are allowed to pass through the uppermost polarization plane 62.

Since the polarization plane is electrically changed by these means, instantaneous switching or conversion between a two-dimensional image display mode and a three-dimensional image display mode is made possible.

In the embodiment, the case that the central lens in the beam controlling element is composed of the biconvex lens has been described. However, when the central lens is composed of a biconcave lens, a three-dimensional image display can be obtained by filling substance with a refractive index smaller than that of substance surrounding the same in the biconcave lens.

In the first and second embodiments, the case that the liquid crystal display device is used as the two-dimensional display device 2 has been explained, but a flat display device such as an organic EL display or an FED (field emission display) may be used as the two-dimensional display device 2.

In the first and second embodiments, the lenticular lens sheet is used as the beam controlling element 10. The lenticular lens sheet is further effective in the stereoscopic image display apparatus, since any light shielding portion depending on a place where a viewer sees an image does not occur and a continuous image can be obtained.

In the first and second embodiments, the lenticular lenses constituting the beam controlling element 10 are arranged in a vertical direction on a screen of the two-dimensional display device 2, but they may be arranged obliquely in order to prevent moire from occurring.

Moreover, in the first and second embodiments, a representing value with respect to an optimal position of a depth of the two-dimensional image is shown and the two-dimensional image of which an image display performance is not deteriorated can also be seen near the representing value.

As explained above, a stereoscopic image display apparatus where switching between a two-dimensional image display mode and a three-dimensional image display mode can be performed within a practical level time.

A method for manufacturing the stereoscopic image display apparatus according to the first embodiment of the invention will be described. A polycarbonate film or an arton film is known as a phase difference film. These films can be given birefringence in plane by extending them in a specific direction. The films are mainly used to cancel a phase difference of liquid crystal cells to diminish color and perform black and white display. Some phase difference films have a uniaxial orientation of nx>ny=nz in a refractive index elliptical body structure. In the birefringent characteristic, when a property of different refractive indexes nx>ny is utilized in plane, image conversion between two-dimension and three-dimension can be performed by combination with the constitutions shown in FIG. 20, FIG. 21, FIG. 22, and FIG. 23. At that time, in such a structure as shown in FIG. 1, in case that the refractive indexes of the first lens and the third lens are n, the birefringence of the second lens is utilized such that nx>n and ny=n are satisfied in the second lens.

For example, since a polycarbonate film has such property as nx=1,585 and ny=1.479, the difference in refractive index Δn becomes 0.106, and a value thereof is substantially the same as that of the difference in refractive index between respective refractive indexes of the birefringence of the liquid crystal described above.

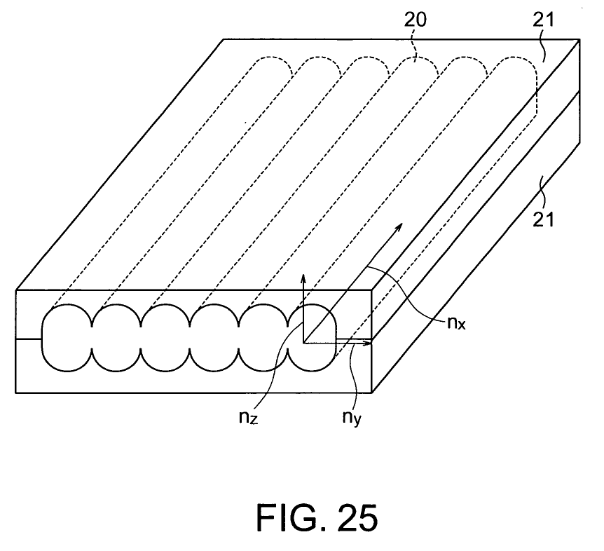

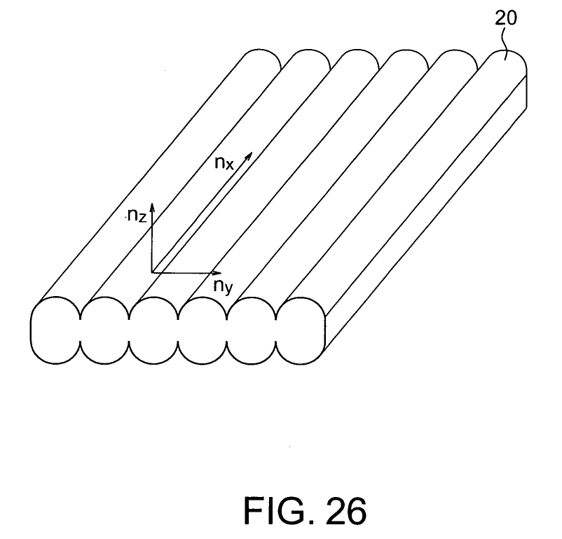

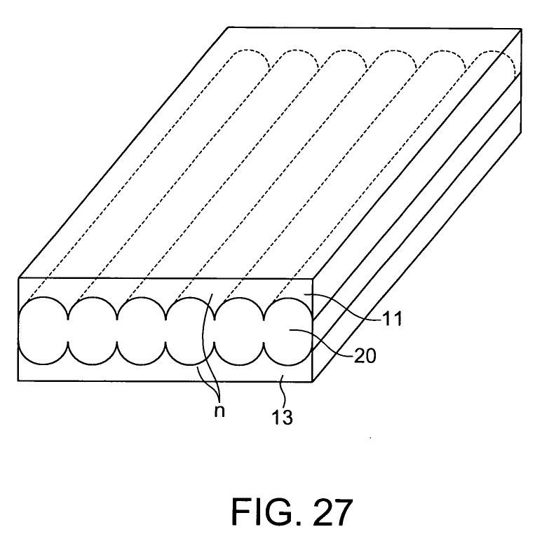

There are thought three kinds of producing methods. A birefringent film 20 with a thickness equal to the maximum thickness of a lens is prepared. As shown in FIG. 25, a die set for lens 21 is prepared and the birefringent film 20 is formed in a lens shape by clamping the film while applying pressure on the same. At that time, setting is performed such that nx with a high refractive index becomes parallel to a lens column. FIG. 26 shows a birefringent lens after stamping for a lens has been performed. FIG. 27 shows an example of the first embodiment using the birefringent lens shown in FIG. 26. Using the die set shown in FIG. 27, a first lens 11 and a third lens 13 are produced and they are adjusted to match with recess and projection of the birefringent lens 20 shown in FIG. 26. At that time, the first lens and the third lens do not have birefringence, but a polarization direction can be controlled to perform conversion between two-dimension and three-dimension by selecting the first and the third lens having refractive indexes approximately equal to ny in FIG. 26. The first and third lenses may be produced as plastic lens separately and they can be produced easily by stamping a silicon rubber.

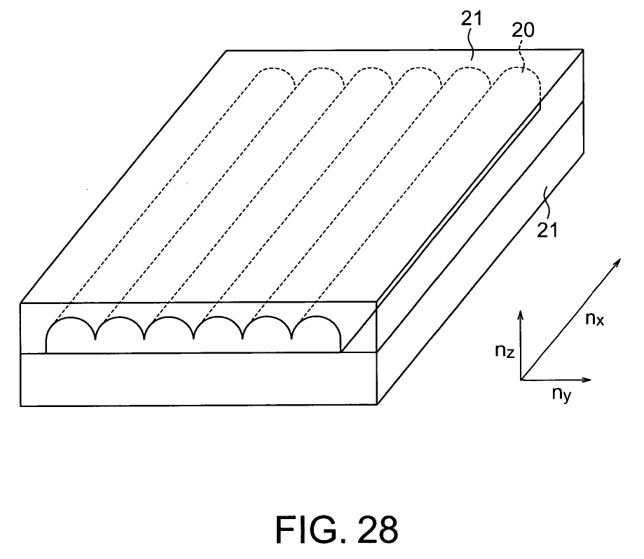

Since the birefringent film is produced by extending the same, it is difficult to produce a thick one. A method applied when a thick birefringent film can not be produced will be described. As shown in FIG. 28, a single-sided convex lens is produced from birefringent material 20 using a lens die. Similarly, a single-sided convex lens with the same shape is produced. A biconvex lens is produced by bonding two single-sided convex lenses on their flat face sides. In order to produce a biconvex lens utilizing the method shown in FIG. 28, it is necessary to position the single-sided convex lenses to each other with a high precision.

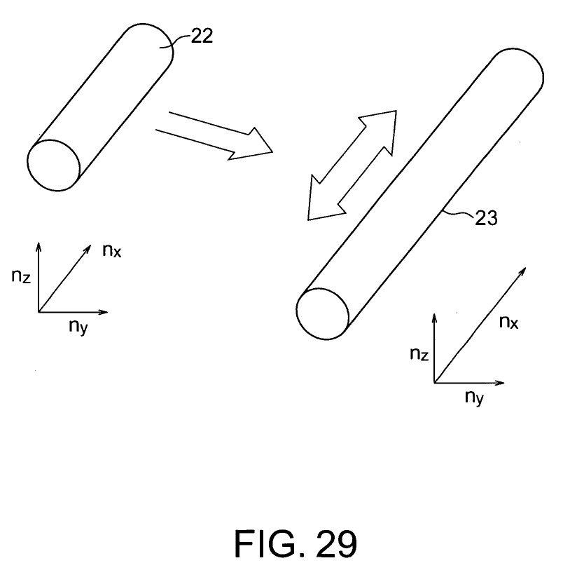

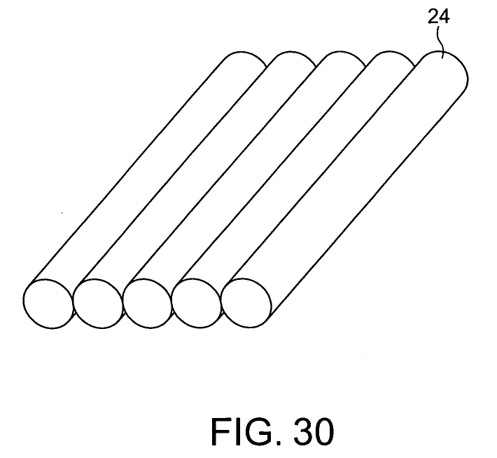

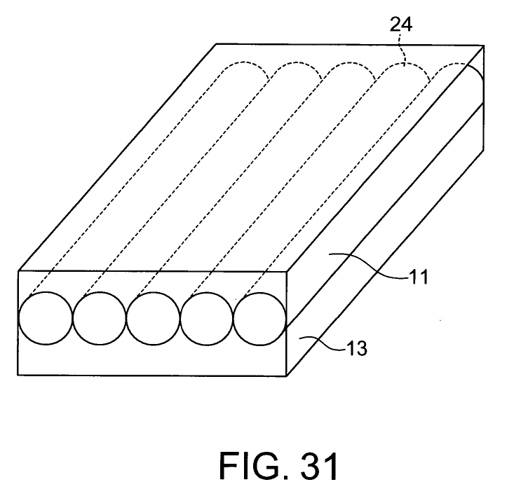

Another method for producing a birefringent lens will be explained. First, material of transparent substance given a birefringent property when extended is prepared. A cylindrical transparent material 22 shown in FIG. 29 can be formed in a cylindrical lens with a desired birefringent property as shown as a cylinder 23 by extending the cylindrical transparent material 22 in a height direction of the cylinder. As shown in FIG. 30, a second lens array according to the first embodiment can be produced by arranging the cylindrical lenses in parallel. As shown in FIG. 31, the lens shown as the first embodiment can be produced by sandwiching the second lens array between the first lens 11 and the third lens 13.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A stereoscopic image display apparatus comprising:
a flat display device which has a display face including a plurality of pixels are arranged in a matrix manner; and
a beam controlling element which is provided on a front face of the flat display device and controls light rays from the pixels, the beam controlling element including
a first lens array which has a plurality of lenses, each lens having a face with a flat shape on a viewer side and a face with a recessed and projected shape on a flat display device side,
a second lens array which has a plurality of lenses, each lens having a face with a flat shape on the flat display device side and a face with a recessed and projected shape approximately equal to the recessed and projected shape of the first lens array in size on the viewer side, and
a third lens array which is provided between the first lens array and the second lens array and has a plurality of lenses, each lens having a face with a recessed and projected shape fitted to the recessed and projected shape in the first lens array on a first lens array side and with a face with a recessed and projected shape fitted to the recessed and projected shape in the second lens array on the second lens array, where a projection of each lens in the third lens array on the first lens array side corresponds to a projection of each lens in the third lens array on the second lens array side, and a recess of each lens in the third lens array on the first lens array corresponds to a recess of each lens in the third lens array on the second lens array side, wherein
the third lens array is configured such that each lens thereof on the first lens array side coincides with a corresponding lens thereof on the second lens array, and
refractive indexes of the first and second lens arrays are approximately the same, and a refractive index of the third lens array is different from the refractive indexes of the first and the second lens arrays.

2. A stereoscopic image display apparatus according to claim 1, wherein the third lens array is made of material whose shape changes freely.

3. A stereoscopic image display apparatus according to claim 1, wherein the third lens array is made of transparent solid material and the first and second lens arrays are formed by stamping recesses and projections of the third lens array using silicon resin.

4. A stereoscopic image display apparatus according to claim 1, wherein each of the first and second lens arrays has a plurality of single-sided concave lenses and the third lens array has a plurality of biconvex lenses.

5. A stereoscopic image display apparatus according to claim 4, wherein, when the minimum lens thickness of each biconvex lens in the third lens array is represented as ds, a viewing zone angle is represented as 2θ, a lens pitch is represented as Iₚ, and a refractive index of the first lens array is represented as n, the biconvex lens satisfies a relationship of
ds×sinθ/(Iₚ×n)<0.1.

6. A stereoscopic image display apparatus according to claim 4, wherein the third lens array is made of material whose shape changes freely.

7. A stereoscopic image display apparatus according to claim 4, wherein the third lens array is made of transparent solid material and the first and second lens arrays are formed by stamping recesses and projections of the third lens array using silicon resin.

8. A stereoscopic image display apparatus comprising:
a flat display device which has a display face including a plurality of pixels arranged in a matrix manner; and
a beam controlling element which is provided on a front face of the flat display device and controls light rays from the pixels including, the beam controlling element including;
a first lens array having a plurality of single-sided concave lenses, each lens having a face with a flat shape on a viewer side and a face with a concave lens shape on a flat display device side,
a second lens array which has a plurality of single-sided concave lenses, each lens having a face with a flat shape on the flat display device side and a face with a concave lens shape approximately equal to the concave lens shape of in size on the viewer side,
a transparent substrate which is provided between the first lens array and the second lens array,
a third lens array which is provided between the first lens array and the transparent substrate and has a plurality of single-sided convex lenses, each lens having a face with a convex lens shape fitted to the concave lens shape of the first lens array on a side of the first lens array and a face with a flat shape on a side of the transparent substrate, and
a fourth lens array which is provided between the transparent substrate and the second lens array and has a plurality of single-sided convex lenses, each lens having a face with a convex lens shape fitted to a concave lens shape of the second lens array and corresponding to a convex lens shape of the third lens array on a side of the second lens array and a face with a flat shape on a side of the transparent substrate, wherein
each single-sided convex lens of the third lens array is composed such that an optical axis thereof coincides with a corresponding single-sided convex lens of the fourth lens array, and
refractive indexes of the first and second lens arrays are approximately the same, and the third and fourth lens arrays are higher in refractive index that the first and second lens arrays.

9. A stereoscopic image display apparatus according to claim 8, wherein the third and fourth lens arrays are made of material having a double refractive index.

10. A stereoscopic image display apparatus according to claim 8, wherein the transparent substrate is composed of first and second transparent substrates.

11. A stereoscopic image display apparatus according to claim 8, wherein the third and fourth lens arrays are made of material whose shape changes freely.

12. A stereoscopic image display apparatus according to claim 11, wherein the third and fourth lens arrays are made of material having a double refractive index.

13. A stereoscopic image display apparatus according to claim 11, wherein the transparent substrate is composed of first and second transparent substrates.

14. A beam controlling element comprising:
a first lens array which has a plurality of lenses, each lens having a face with a flat shape on one side and a face with a recessed and projected shape on the other side,
a second lens array which has a plurality of lenses, each lens having a face with a flat shape on one side and a face with a recessed and projected shape approximately equal to the recessed and projected shape in the first lens array on the other side, and
a third lens array which is provided between the first lens array and the second lens array and has a plurality of lenses, each lens having a face with a recessed and projected shape fitted to the recessed and projected shape in the first lens array on a first lens array side and with a face with a recessed and projected shape fitted to the recessed and projected shape in the second lens array on the second lens array, where a projection of each lens in the third lens array on the first lens array side corresponds to a projection of each lens in the third lens array on the second lens array side, and a recess of each lens in the third lens array on the first lens array corresponds to a recess of each lens in the third lens array on the second lens array side,
wherein refractive indexes of the first and second lens arrays are approximately the same, and a refractive index of the third lens array is different from the refractive indexes of the first and the second lens arrays.

15. A beam controlling element according to claim 14, wherein the third lens array is configured to arrange cylindrical lenses so that longitudinal axes of the cylindrical lenses are in parallel.

16. A beam controlling element according to claim 15, wherein each of the cylindrical lenses has a birefringence index in which refractive index in a longitudinal axis direction is different from that in a lateral axis direction.

17. A beam controlling element according to claim 16, wherein the refractive index in the lateral axis direction is equal to one of the refractive indexes of the first and second lens arrays.

18. A beam controlling element comprising:
a first lens array having a plurality of single-sided concave lenses, each lens having a face with a flat shape on one side and a face with a concave lens shape on the other side,
a second lens array which has a plurality of single-sided concave lenses, each lens having a face with a flat shape on one side and a face with a concave lens shape approximately equal to the concave lens shape in size on the other side,
a transparent substrate which is provided between the first lens array and the second lens array,
a third lens array which is provided between the first lens array and the transparent substrate and has a plurality of single-sided convex lenses, each lens having a face with a convex lens shape fitted to the concave lens shape of the first lens array on a side of the first lens array and a face with a flat shape on a side of the transparent substrate, and
a fourth lens array which is provided between the transparent substrate and the second lens array and has a plurality of single-sided convex lenses, each lens having a face with a convex lens shape fitted to a concave lens shape of the second lens array and corresponding to a convex lens shape of the third lens array on a side of the second lens array and a face with a flat shape on a side of the transparent substrate, wherein refractive indexes of the first and second lens arrays are approximately the same, and the third and fourth lens arrays are higher in refractive index that the first and second lens arrays.

19. A beam controlling element according to claim 18, wherein the third lens array is configured to arrange cylindrical lenses so that longitudinal axes of the cylindrical lenses are in parallel.

20. A beam controlling element according to claim 19, wherein each of the cylindrical lenses has a birefringence index in which refractive index in a longitudinal axis direction is different from that in a lateral axis direction.

21. A beam controlling element according to claim 20, wherein the refractive index in the lateral axis direction is equal to one of the refractive indexes of the first and second lens arrays.
